(19) United States
(12) Patent Application Publication
(10) Pub. No.: US 2014/0146074 A1
(43) Pub. Date: May 29, 2014

(54) Intelligent Homescreen for Mobile Devices

(71) Applicant: FUTUREWEI TECHNOLOGIES, INC., Plano, TX (US)

(72) Inventor: Young Hoon Kwon, San Diego, CA (US)

(73) Assignee: FUTUREWEI TECHNOLOGIES, INC., Plano, TX (US)

(21) Appl. No.: 13/686,723

(22) Filed: Nov. 27, 2012

(51) Int. Cl. G09G 5/00

(52) U.S. Cl. CPC G09G 5/003
USPC 345/619

(57) ABSTRACT

An embodiment mobile device includes an environment sensing unit configured to sense parameters of an environment, a data processing unit in communication with the environment sensing unit, the data processing unit configured to compile usage statistics based previously sensed parameters of the environment and to determine if any applications correspond to the environment based on currently sensed parameters of the environment and the usage statistics stored in a memory, and a display in communication with the data processing unit, the display configured to display on a homescreen the applications that correspond to the environment.

### TECHNICAL FIELD

The present disclosure relates to a mobile device and, in particular, to a homescreen for a mobile device.

### BACKGROUND

A homescreen is typically the first page that a user interacts with on a mobile device (e.g., cellular phone, tablet, etc.). Depending on the homescreen design, the number of touches or tabs to reach a desired application may vary considerably. As such, the user-friendliness of the mobile device heavily depends on the design and functionality of the homescreen.

### SUMMARY

An embodiment mobile device includes an environment sensing unit configured to sense parameters of an environment, a data processing unit in communication with the environment sensing unit, the data processing unit configured to compile usage statistics based previously sensed parameters of the environment and to determine if any applications correspond to the environment based on currently sensed parameters of the environment and the usage statistics stored, and a display in communication with the data processing unit, the display configured to display on a homescreen the applications that correspond to the environment.

An embodiment method of displaying a homescreen on a display of a mobile device includes sensing, by an environment sensing unit, parameters of an environment, determining, by a data processing unit, if any applications correspond to the environment based on currently sensed parameters for the environment and usage statistics compiled using previously sensed parameters for the environment, and displaying on the homescreen, using the display, the applications that correspond to the environment.

An embodiment computer readable medium containing program instructions for displaying a homescreen on a display of a mobile device, wherein execution of the program instructions by one or more processing units of the mobile device causes the one or more processing units to carry out the steps of: sense parameters of an environment, determine if any applications correspond to the environment based on currently sensed parameters for the environment and usage statistics compiled using previously sensed parameters for the environment, and display on the homescreen of the display the applications that correspond to the environment.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an embodiment mobile device is illustrated;

FIG. 2 illustrates a homescreen of the embodiment mobile device of FIG. 1; and

FIG. 3 illustrates a method of displaying the homescreen on a display of the mobile device of FIGS. 1-2.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present disclosure provides many applicable inventive concepts that can be embodied in a wide variety of specific contexts. The specific embodiments discussed are merely illustrative and do not limit the scope of the disclosure.

The present disclosure will be described with respect to preferred embodiments in a specific context, namely a mobile device. The concepts in the disclosure may also apply, however, to other types of devices or systems.

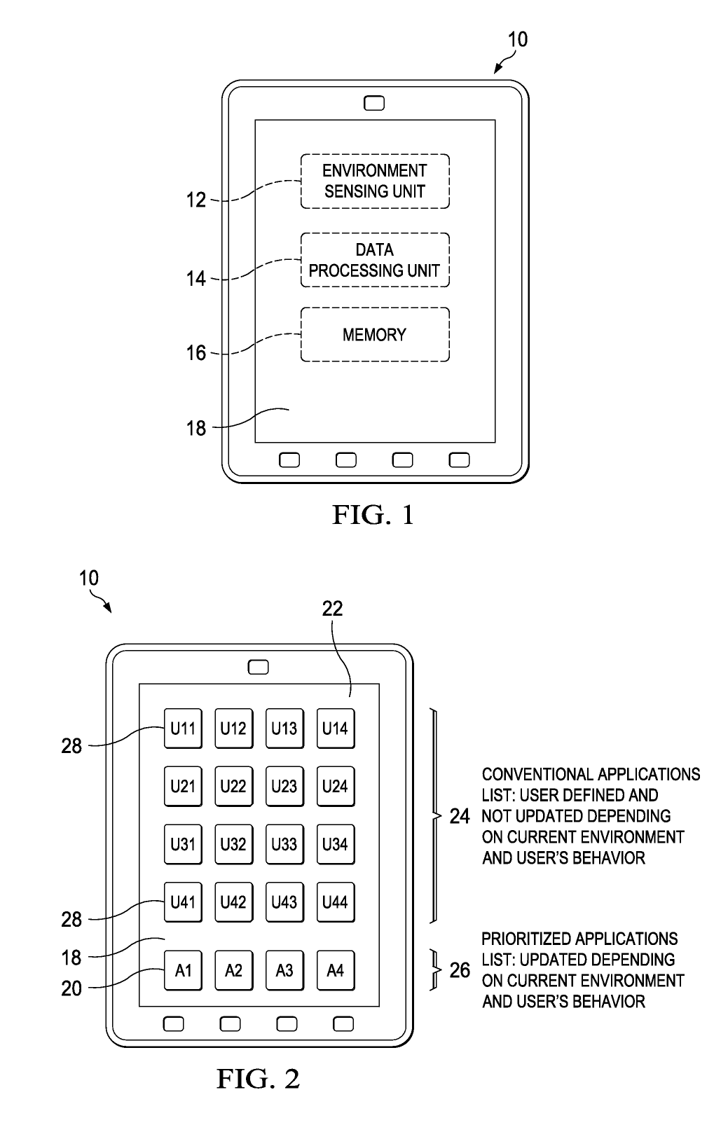

Referring now to FIG. 1, a mobile device 10 is illustrated. As will be more fully explained below, the mobile device 10 automatically displays the applications that correspond to the environment of the mobile device 10 on the homescreen when the screen is unlocked or the mobile device 10 is turned on. As such, the mobile device 10 presents to the user with the most appropriate or desirable applications when the user is first greeted with the homescreen. By operating in this manner, user interaction is minimized and user satisfaction is improved, particularly with regard to the homescreen.

As shown in FIG. 1, the mobile device 10 includes an environment sensing unit 12, a data processing unit 14, memory 16, and a display 18. The environment sensing unit 12 is configured to sense one or more parameters of an environment. Such parameters include, but are not limited to, a location of the mobile device 10, a current time, a schedule, whether a different mobile device is nearby, the movement of the mobile device 10, and combinations thereof. In order to do so, the environment sensing unit 12 may include, for example, a global positioning system (GPS) receiver, a clock feature, a calendar or reminder feature, a radio frequency (RF) or wireless fidelity (WiFi) sensing feature, one or more antennas, and/or motion sensors (e.g., gyroscope, accelerometer).

While the environment sensing unit 12 is represented by a single block in FIG. 1, the environment sensing unit 12 may be implemented through several separate and discrete components or modules configured to operate independently and/or cooperatively. In addition, embodiments of environment sensing unit 12 may be implemented using software, hardware, firmware, and combinations thereof.

Referring now to FIGS. 1-2, the data processing unit 14 is in communication with the environment sensing unit 12, the memory 16, and the display 18. The data processing unit 14 is configured to compile usage statistics based on the parameters previously observed by the environment sensing unit 12 relative to the environment. The usage statistics may indicate, for example, that between 7 a.m. and 8 a.m. on Monday through Friday there is a 90% chance that the user will read work-related electronic mail messages on the mobile device 10. As another example, the usage statistics may indicate that, for example, the user is more likely than not to view news and sports related websites after 8 p.m. on a Saturday night while the user is at the user's residence. From the foregoing, it should be recognized that the usage statistics will reveal patterns in the user's behavior, which patterns may be used by the mobile device 10 to improve user experience. Such usage statistics may be stored in the memory 16. The data processing unit 14 is also configured and operable to determine if any applications 20 correspond to the environment based on the usage statistics stored in, and retrieved from, the memory 16. In order to do so, the data processing unit 14 may include one or more processors, a central processing unit (CPU), an electronic data processor, and the like.

While the data processing unit 14 is represented by a single block in FIG. 1, the data processing unit 14 may be implemented through several separate and discrete components or modules configured to operate independently and/or cooperatively. In addition, embodiments of data processing unit 14 may be implemented using software, hardware, firmware, and combinations thereof.

Still referring to FIG. 1, the memory 16 is in communication with the environment sensing unit 12, the data processing unit 14, and the display 18. As such, the data processing unit 14 is able to retrieve the saved or stored usage statistics from the memory 16. The memory 16 may reside within the mobile device 10 or in a server or computing device remotely located relative to the mobile device 10. While the memory 16 is represented by a single block in FIG. 1, the memory 16 may be implemented through several separate and discrete components configured to operate independently and/or cooperatively.

In an embodiment, the memory 16 stores the parameters sensed by the environment sensing unit 12 and processed by the data processing unit 14. The memory 16 may comprise any type of system memory such as static random access memory (SRAM), dynamic random access memory (DRAM), synchronous DRAM (SDRAM), read-only memory (ROM), a combination thereof, or the like. In an embodiment, the memory 16 may include ROM for use at boot-up, and DRAM for program and data storage for use while executing programs.

Referring now to FIG. 2, the display 18 is in communication with the data processing unit 14. The display 18 is able to display a variety of information for the user of the mobile device 10, including the homescreen 22. The homescreen 22 typically greets the user when the display 18 is unlocked, when the mobile device 10 is turned on, and so on. In an embodiment, the homescreen 22 includes a first portion 24 typically dedicated to the applications 20 that are based on the usage statistics. In an embodiment, the homescreen 22 also includes a second portion 26 typically dedicated to default applications 28. While the first portion 24 is depicted below the second portion 26 in FIG. 2, the first and second portions 24, 26 may be otherwise arranged in other embodiments.

As shown in FIG. 2, the homescreen 22 on the display 18 is able to provide a listing or group of the applications 20 that correspond to the environment based on the usage statistics. In an embodiment, the applications 20 that correspond to the environment are disposed in the first portion 24 of the homescreen 22. In an embodiment, the homescreen 22 of the display 18 may depict both the default applications 28 in the second portion 26 of the homescreen 22 and the applications 20 that correspond to the environment in the first portion 24 of the homescreen 22.

If usage statistics reveal that none of the applications 20 correspond to the environment, then the mobile device 10 may populate the first portion 24 of the homescreen 22 with some of the default applications 28. In an embodiment, the default applications 28 in the first portion 24 of the homescreen 22 are displayed by category, or based on which of the applications was most recently used, etc. If usage statistics reveal that none of the applications 20 correspond to the environment, then the homescreen 22 on the display 18 may also have only the default applications 28 shown in the second portion 26.

In an embodiment, the default applications 28 in the second portion 26 of the homescreen 22 are displayed in a user defined format, or by category, and/or based on which of the applications was most recently used. In an embodiment, the default rules used to determine which of the default applications 28 are displayed in the first portion 24 of the homescreen 22 are different than the default rules used to determine which of the default applications 28 are displayed in the second portion 26 of the homescreen.

In an embodiment, the applications 20 and/or the default applications 28 are depicted on the homescreen 22 as an icon and/or a hyperlink (i.e., link to a uniform resource locator (URL)). The applications 20 and/or the default applications 28 may be accessed or launched by, for example, touching the icon or the link corresponding to the particular application.

In an embodiment, the environment sensing unit 12 automatically senses the parameters of the environment when one of the applications 20 or default applications 28 is launched by the user of the mobile device 10. Therefore, the mobile device 10 is configured to automatically provide the applications 20 that correspond to the environment on the homescreen 22 without user input.

While not shown in FIGS. 1-2, the mobile device 10 may also include one or more additional I/O interfaces operably coupled to the environmental environment sensing unit 12 and/or the data processing unit 14. For example, the mobile device 10 may utilize a mouse, keyboard, printer, and so on. In addition, the mobile device 10 may include a mass storage device and a video adapter providing interfaces to couple external input and output devices to the data processing unit 14. The mass storage device may comprise any type of storage device configured to store data, programs, and other information and to make the data, programs, and other information accessible via a bus. The mass storage device may comprise, for example, one or more of a solid state drive, hard disk drive, a magnetic disk drive, an optical disk drive, or the like.

The mobile device 10 may also include one or more network interfaces, which may comprise wired links, such as an Ethernet cable or the like, and/or wireless links to access nodes or different networks. The network interface allows the data processing unit 14 to communicate with remote systems or units via the networks. For example, the network interface may provide wireless communication via one or more transmitters/transmit antennas and one or more receivers/receive antennas. In an embodiment, the data processing unit 14 is coupled to a local-area network or a wide-area network for data processing and communications with remote devices, such as other processing units, the Internet, remote storage facilities, or the like.

In an embodiment, one or more of the units or components disclosed herein communicates through a bus. The bus may be one or more of any type of several bus architectures including a memory bus or memory controller, a peripheral bus, video bus, or the like.

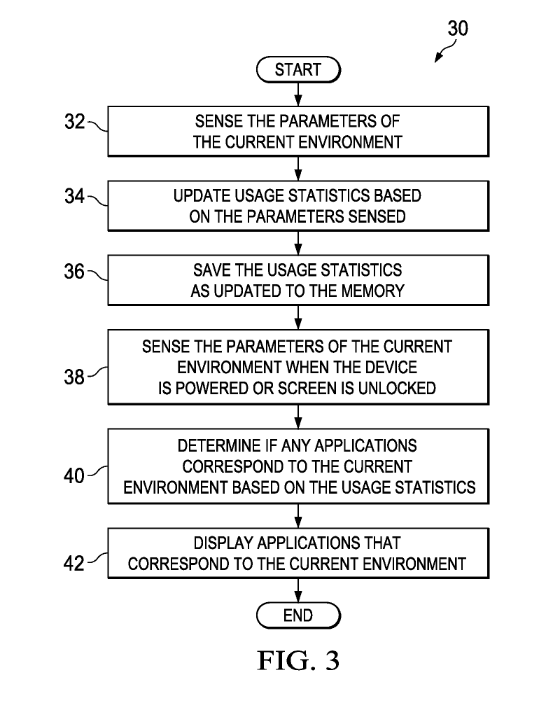

Referring now to FIG. 3, a method 30 of displaying the homescreen 22 on the display 18 of the mobile device 10 is illustrated. In block 32, the mobile device 10 measures or senses the parameters of the environment while the mobile device is unlocked or actively being used. Such parameters include, but are not limited to, a location of the mobile device 10, a current time, a schedule, whether a different mobile device is nearby, the movement of the mobile device 10, and combinations thereof. The measurement or sensing may occur when, for example, the user launches a particular application. However, the measurement or sensing may also occur at other times or with other triggers. In block 34, the mobile device 10 estimates and updates the usage statistics based on the parameters that were measured and sensed. For example, if the user's typical pattern of streaming live music from particular website at around 10 p.m. on the weekends changed to the user now viewing videos from an application on the computer at around 10 p.m. on the weekends, the usage statistics would be updated to reflect that change. In block 36, the updated usage statistics are saved to the memory 16.

In block 38, the mobile device 10 measures or senses the parameters of the environment when, for example, the display 18 (i.e., screen) is unlocked or the mobile device 10 is turned on (as opposed to when the mobile device was already being used, in block 32). In block 40, the mobile device 10 determines if any applications correspond to the environment based on the usage statistics, which were compiled based on the previously sensed parameters for the environment. In other words, the mobile device 10 automatically implements a heuristic approach to displaying the applications 20 on the homescreen 22 without input from the user.

In block 42, the mobile device 10 displays on the homescreen 22 the applications 20 that correspond to the environment. If none of the applications 20 correspond to the environment, the default applications 28 may be displayed, the last set of applications 20 that were displayed may be displayed again, and so on. Moreover, the default applications 28 may be displayed in addition to those applications 20 that correspond to the environment.

Several examples of how the above method 30 may be put into practice in real-world scenarios are provided in the following paragraphs. For instance, a user typically uses his smartphone to look at on-line newspapers when he gets home from work in the evening. In this situation, the smartphone monitors the user's Internet browsing pattern and recognizes that the user prefers to view specific news websites (e.g., Wall Street Journal) at a specific location (e.g., the user's home) at a specific time (e.g., around 6 p.m.). As such, when the user unlocks the screen of his smartphone at home after work, the homescreen 22 automatically includes icons or links for the news websites that are usually visited at that time and place.

As another example, a user often checks her e-mail on the way to work while riding public transportation. In this situation, the tablet monitors the user's e-mail usage pattern and recognizes that the user prefers to check her e-mail (e.g., work and/or personal e-mail accounts) along a specific route (e.g., the public transportation route to work) at a specific time (e.g., between 7 a.m. and 8 a.m.). As such, when the user unlocks the screen of her tablet one the way to work, the homescreen 22 automatically includes icons or links for quickly accessing the e-mail accounts usually viewed at that time and along that route.

As an additional example, a user has stored a client meeting in the calendar on his tablet. The user may have also set a reminder for the meeting. The user typically uses his table for the presentation that will be given to the client. In this situation, the tablet monitors the user's schedule and realizes that the user plans to give the presentation at the meeting time. As such, when the user unlocks the screen of his tablet a few minutes before the client meeting, the homescreen 22 automatically includes icons or links for quickly accessing the presentation at the time scheduled for the client meeting.

From the foregoing, it should be recognized that the mobile device 10 is able to automatically and autonomously estimate a usage pattern of the user at each given environment and update the preferred applications list on the homescreen 22 accordingly. As such, end-user interaction needed to go directly to the desired application when a user turns on the mobile device is minimized. By prioritizing the applications depicted on the homescreen 22 of the display 18, the overall user satisfaction of the mobile device 10 is increased.

While the disclosure provides illustrative embodiments, this description is not intended to be construed in a limiting sense. Various modifications and combinations of the illustrative embodiments, as well as other embodiments, will be apparent to persons skilled in the art upon reference to the description. It is therefore intended that the appended claims encompass any such modifications or embodiments.

What is claimed is:

1. A mobile device, comprising:
an environment sensing unit configured to sense parameters of an environment;
a data processing unit in communication with the environment sensing unit, the data processing unit configured to compile usage statistics based on previously sensed parameters of the environment and to determine if any applications correspond to the environment based on currently sensed parameters of the environment and the usage statistics stored; and
a display in communication with the data processing unit, the display configured to display on a homescreen the applications that correspond to the environment.

2. The mobile device of claim 1, wherein the parameters of the environment include one or more of a location, time, schedule, nearby mobile device, movement, and combinations thereof.

3. The mobile device of claim 1, wherein the display is configured to display one or more default applications on the homescreen in addition to the applications that correspond to the environment.

4. The mobile device of claim 1, wherein the display is configured to display one or more default applications on the homescreen if none of the applications correspond to the environment.

5. The mobile device of claim 4, wherein the default applications may be displayed in a first portion of the homescreen based on a first set of default rules and in a second portion of the homescreen based on a second set of default rules different than the first set of default rules.

6. The mobile device of claim 4, wherein the default applications are displayed on the homescreen in a user defined format.

7. The mobile device of claim 4, wherein the default applications are displayed on the homescreen by category.

8. The mobile device of claim 4, wherein the default applications displayed on the homescreen are one or more recently used applications.

9. The mobile device of claim 1, wherein the data processing unit is configured to update the usage statistics based on the currently sensed parameters of the environment.

10. The mobile device of claim 1, wherein the usage statistics include information regarding a particular application being used at the environment.

11. The mobile device of claim 1, wherein the environment sensing unit automatically senses the parameters of the environment when one of the applications is launched by a user.

12. The mobile device of claim 1, wherein the application is displayed on the homescreen as one of an icon and a link.

13. The mobile device of claim 1, wherein the display is configured to automatically display on the homescreen the applications that correspond to the environment without user input.

14. The mobile device of claim 1, wherein the memory resides within the mobile device.

15. The mobile device of claim 1, wherein the memory is resident in a server remotely located relative to the mobile device.

16. A method of displaying a homescreen on a display of a mobile device, comprising:
sensing, by an environment sensing unit, parameters of an environment;
determining, by a data processing unit, if any applications correspond to the environment based on currently sensed parameters for the environment and the usage statistics compiled using previously sensed parameters for the environment; and
displaying on the homescreen, using the display, the applications that correspond to the environment.

17. The method of claim 16, further comprising retrieving the usage statistics from a memory.

18. The method of claim 16, wherein the usage statistics are based on previously sensed parameters of the environment.

19. The method of claim 16, wherein the usage statistics include information regarding a particular application being used at the environment.

20. The method of claim 16, further comprising storing the usage statistics in a memory prior to the sensing step.

21. The method of claim 16, wherein the parameters of the environment include one or more of a location, time, schedule, nearby mobile device, movement, and combinations thereof.

22. The method of claim 16, further comprising displaying one or more default applications on the homescreen if none of the applications correspond to the environment.

23. The method of claim 16, further comprising displaying one or more default applications on the homescreen in addition to the applications that correspond to the environment.

24. The method of claim 16, further comprising automatically sensing the parameters of the environment when one of the applications is launched by a user.

25. The method of claim 16, further comprising displaying the application on the homescreen as one of an icon and a link.

26. A computer readable medium containing program instructions for displaying a homescreen on a display of a mobile device, wherein execution of the program instructions by one or more processing units of the mobile device causes the one or more processing units to implement a method comprising:
sensing parameters of an environment;
determining if any applications correspond to the environment based on currently sensed parameters for the environment and on usage statistics compiled using previously sensed parameters for the environment; and
displaying on the homescreen of the display the applications that correspond to the environment.

27. The computer readable medium of claim 26, wherein the parameters of the environment include one or more of a location, time, schedule, nearby mobile device, movement, and combinations thereof.

28. The computer readable medium of claim 26, further comprising displaying one or more default applications on the homescreen if none of the applications correspond to the environment.

29. The computer readable medium of claim 26, further comprising automatically updating the usage statistics when one of the applications is launched by a user.

30. The computer readable medium of claim 26, further comprising automatically displaying on the homescreen the applications that correspond to the environment without user input.
